(19) United States
(12) Patent Application Publication
(10) Pub. No.: US 2023/0393547 A1
(43) Pub. Date: Dec. 7, 2023

(54) HUMAN-MACHINE EXECUTION SYSTEM APPLIED TO MANUFACTURING

(71) Applicant: Full Speed Automation, Inc., Los Gatos,, CA (US)

(72) Inventor: Luc Leroy, Los Gatos, CA (US)

(21) Appl. No.: 18/248,422

(22) PCT Filed: Oct. 11, 2021
(86) PCT No.: PCT/US2021/054414

§ 371 Date: Apr. 10, 2023

Related U.S. Application Data
(60) Provisional application No. 63/090,471, filed on Oct. 12, 2020.

(51) Int. Cl. G05B 19/05

(52) U.S. Cl. CPC G05B 19/05; G05B 2219/13144

(57) ABSTRACT

An integrated human-machine execution system and related method for manufacturing automation, includes a computer, a graphical user interface, one or more programmable input/outputs, one or more human-machine interface components, and a network adapter. The computer is enabled to execute all necessary software to operate the functions of the integrated system and orchestrate the execution of one or more automated manufacturing operations. In some examples, data updates are event-based instead of time-based such that data updates transmitted by the system when data value changes initiate an event, independently of time elapsed since occurrence of a prior event. The system can be configured to connect to an external and discrete programmable logic controller attached an automation component and instructions to the automation component are instantiated at the human-machine execution system, obviating the need for programming at the programmable logic controllers.

### CROSS REFERENCE TO RELATED APPLICATIONS

This application is the National phase under 35 U.S.C. § 371 of International Application No. PCT/US2021/054414, filed Oct. 11, 2021, which claims priority to U.S. Provisional Application No. 63/090,471 filed on Oct. 12, 2020. The entire contents of these patent applications are hereby incorporated by reference herein.

### TECHNICAL FIELD

The present invention generally relates to automation controls technology and specifically to a consolidated human-machine execution system useful for manufacturing automation.

### BACKGROUND ART

Since the introduction of programmable logic controllers in the field of automation controls, the capabilities of computers have greatly improved, with faster microprocessors allowing greater compute, larger and faster memory enabling the execution of larger and more complex programs that manipulate larger amounts of data. Network interconnectivity has also dramatically improved and components that used to be connected to programmable logic controllers (PLC), such as the early Allen Bradley PLC, via direct wires driving analog signals are now often communicating with the logic controller over Ethernet or similar network protocols. Over time, programmable logic computers have grown into computers to such an extent that nowadays popular programmable logic controllers use electronics similar to personal computers such as a computer system based on an Intel processor and are capable of running an operating system designed for personal computers, professional workstations and servers such as Microsoft Windows, different distributions of Linux or similar operating systems. Popular examples of such modern programmable logic controllers are the Siemens SIMATIC or the Beckhoff CX families of controllers.

Requirements and practices in the field of manufacturing have similarly evolved. Modeling tools have allowed the complexity of equipment, manufacturing lines and factories to grow significantly. It is not uncommon to observe hundreds of devices—from basic sensors to sophisticated industrial robots, connected to a single controller. The frequency and amount of data transferred across controllers and components has followed the same trend. Hundreds of megabytes of data transferred per second with latencies measured in milliseconds and sometimes microseconds for specialized controllers is a common trade. Data related to material flow, supply chain, product quality, human resources and a myriad of other fields are now part of the data manipulated by controllers and manufacturing execution systems.

Human-machine interfaces have historically been discrete from and connected to the programmable logic controller. More recently, following the increasing connectivity in factories and the growing usage of servers, these interfaces can be connected to a server which receives information from the programmable logic controller directly or indirectly, and the human-machine interface principally consist of a user interface on a computer display.

It is also common to find a manufacturing execution system hosted on a server possibly outside of the manufacturing premise and sometimes on a distributed system. The manufacturing execution server is responsible for collecting cycle data from programmable logic controllers, and sending data to these controllers in order to orchestrate manufacturing and coordinate material flow and other systems.

Other devices and systems such as, for example, smart cameras used for quality control or presence sensors are conventionally discrete from, but directly connected to, a manufacturing execution system server. Such increase in the number of connected devices and systems in factories has led to a growing traffic over the network infrastructure, and more complexity to manage connections. One critical aspect of managing these connections is to ensure that the network capacities in the factory are aligned with the bandwidth requirements to transfer data in an adequate timely manner, so that the numerous devices and components can act under the time allowed. This is particularly true for safety and shutoff devices and components, which must act and react in short periods of time varying from microseconds to a few milliseconds. The type of connections—wherever they should be analog or digital, can be selected appropriately to optimize the performance of communications between components.

Modern programmable logic controllers typically support multiple types of connections to facilitate the fulfilling of these connectivity requirements. For instance, multiple analog ports are available as communication extensions that can be connected to the core unit of the controller. The core controller uses a proprietary protocol such as EthernetIP, Profinet or EtherCAT developed by Allen-Bradley, Siemens and Beckhoff, respectively, to connect with most automation devices such as actuators, motors, sensors and robots. Also, since the early 2000's most programmable logic controllers have been equipped with at least one Ethernet port which allows them to communicate with the enterprise's network.

The multitude of devices, types of connections and the roles and responsibilities of all these components is resulting in growing complexity and cost of equipment and implementation of automation controls. This is leading to a suboptimal solution where certain programmable logic controllers that are still using less efficient means of programming interact with systems that use the latest technologies available. For instance, some traditional programmable logic controllers are programmed using a ladder logic language which limits the complexity of the programs that can be written and requires more time to write than using modern software languages such as Python, Java, C, C++ or C #.

Determinism is a key requirement in the selection of the language used to program the controllers that interface with multiple devices critical to the execution and safety of manufacturing equipment. High-level interpreted languages such as Python and javascript are appealing to quickly develop complex programs. However, such languages cannot offer the assurance that code execution will consistently be insured with a predictable timing. They may be suitable to the development of user interfaces, part of the human-machine interfaces for a manufacturing automation system but should not be used to develop the logic that will orchestrate and/or interface with equipment and automation devices.

To produce more efficient, cost effective and evolutive automation controls systems the present invention simplifies the complexity of such systems by consolidating key functionalities, such as the time-critical aspects of the manufacturing execution system, the human-machine interfaces and some of the complex logic that is traditionally executed in programmable logic controllers, all into one system: a human-machine execution system, sometimes referred to herein as the HME system or the controller.

### DESCRIPTION OF THE INVENTION

In some embodiments, the HME system comprises a human-machine interface comprising a graphic user interface controlled by one or more input devices, such as a touch screen or a mouse and keyboard. The graphical user interface is executed by an embedded computer within the HME system that possesses one or more connectors to control and read from automation control devices such as motors, sensors, stack lights, scanners, and the like.

Unlike existing systems which traditionally separate the user interface from other aspects of the human-machine interface, such as hand-held tools and buttons which are usually connected to the programmable logic controller, the HME system combines all the functions of the human-machine interface into an integrated controller. This includes safety features such as emergency stop buttons that can be connected to the human-machine execution system that controls the equipment that needs to be urgently stopped when an emergency stop is invoked. FIG. 1 presents the disposition of inputs and outputs directly connected to the embedded computer, which allows the same program for controlling automation components connected to this computer to also handle the user interfaces and related components that comprise the human-machine interface.

The architecture of the present invention is a significant improvement over the traditional model where the different components necessary to fulfill the functions of human-machine interface are separately connected to the programmable logic controller through different networks and the input/outputs. FIG. 2 highlights how these connections are typically set in a traditional automation controls setup using a programmable logic controller. This complexity results in a confusion about the roles and responsibilities of each layer or connection and does not focus on performance constraints such as bandwidth and latency. For instance, a sensor which signal is used to actuate the position of a servo drive in micro or milliseconds, can be connected to the same network or bus than a button for a human-machine interface which responsiveness can be hundreds of times slower as it is usually accepted that a system responds to a non-safety critical button in hundreds of milliseconds or even a couple seconds. The human-machine execution system's architecture regroups all the components of the human-machine interface which are handled by a single computer. This results in a greater ease of implementation, the ability to author the whole user interface and manufacturing process from a single program which can be authored on a similar or the very same device that will ensure the execution of the manufacturing process in the factory. The advantages of the present invention are a lower cost, a greater efficiency, the ability to author, test and execute in one place, and deploy updates to the programs rapidly.

In some embodiments, the system is based on an Intel-based computer architecture augmented with a micro-controller and custom firmware to enable the exchange of data between the Intel processor and the microcontroller. FIG. 3 is a simplified representation of the architecture. In some embodiments, this supports conventional operating systems such as Microsoft Windows and Linux, and is compatible with most modern development tools that support C++ or C #languages. This allows the leveraging of integrated development environment tools such as Microsoft Visual Studio, CLion, Eclipse or QT Creator to mention a few of them. The using of C++ or C #ensures an acceptable level of determinism for automation controls including safety critical tasks; while allowing the largest portion of the community of software developers to develop and contribute to the system as they are already familiar with these languages. These languages are also widely supported by source control systems and repositories such as Git, Perforce, SVN to mention a few of them. Therefore, source control can be used to easily implement a continuous integration system and leverage modern software engineering practices that have been recently developed and widely used in the development and deployment of software for smart devices, computers, servers and connected devices such as robots and vehicles. Continuous integration and continuous deployment allow for rapid iterations in the manufacturing facility on both the process, human-machine interface and equipment orchestration.

Another advantage of the HME system is that telemetry from all components connected to the human-machine execution system as the primary controller for the human-machine interface, as well as automation controls components such as motors and sensors for which the behavior is driven by the human-machine interface, can be easily implemented. The execution computer that manipulates all these signals samples them at a desired frequency, stores them locally in a database or in files directly stored on the local storage, and systematically broadcasts these signals to remote systems. The broadcasting of these signals can be performed through multiple formats or protocols. In one embodiment, the invention publishes data through, an open-source stream-processing software such as Kafka or MOTT, so that clients can subscribe and utilize this data, and also sends the data to a remote telemetry server via websockets so that consumers can view the data related to the telemetry in real time on the Internet.

Safety is another important benefit, since the invention has built-in support for emergency stop buttons. The execution software supports redundant connections to one or more emergency stop buttons and is guaranteed to stop the motion of any motor or actuator connected to the controller within 10 milliseconds. This allows automation controls on the manufacturing site to not have to implement such behavior and manage to pass a safety buyoff that involves the review of wiring, code, test procedures, etc. After the built-in safety system has been reviewed and approved out the outset by the health and safety department of a manufacturer, many instances of the system can be deployed in factories without the need for additional safety review, provided the code responsible for the safety aspect of the programs running in the controller does not change.

The ability to develop a user interface and a manufacturing process without the need to write code is another important advantage of the present invention. All components connected to the controller have a graphic representation as well as strictly formatted programmatic interfaces that expose properties and events. Using preferably the integrated development environment authoring tool such as the built-in user interface designer, users can instantiate and program the behavior of these components in a visual way. This dramatically reduces the time to implement the user interface and the logic of the process and avoids the introduction of undesired behavior in the code, which leads to potential defects. One embodiment uses Microsoft Visual Studio's User Interface Design tool to place components in the user interface, interconnect their interfaces and describe their configuration and behavior. The ability to edit the code is still possible, when the process requires specific changes that the properties and events exposed through the user interface don't allow. To achieve such efficiency improvement, a library installed into the integrated development environment is capable of generating code that exposes the commands and properties available for each automation component.

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure invention and is not meant to limit the inventive concepts disclosed herein.

The accompanying drawings, which are incorporated in and constitute a part of the specification, illustrate embodiments of the disclosure and together with the general description of the disclosure given above and the detailed description of the drawings, given below, explain the principles of the disclosure.

FIG. 1 is a schematic representation of the architecture of an embodiment of the HME system.

FIG. 2 is a schematic representation of the architecture of traditional programmable logic controller systems that rely on discrete components.

FIG. 3 is a schematic representation of the internal architecture of the computer of the HME system.

FIG. 4A is a diagram of a set of exemplary automation controllers.

FIG. 4B is a snippet of a graphical user interface pertaining to the controller.

FIG. 4C is another snippet of a graphical user interface pertaining to the controller.

FIG. 4D is yet another snippet of a graphical user interface pertaining to the controller.

The drawings are not necessarily to scale. In certain instances, details that are not necessary for an understanding of the disclosure or that render other details difficult to perceive may have been omitted. It should be understood, of course, that the disclosure is not necessarily limited to the embodiments illustrated herein.

### BEST MODE FOR CARRYING OUT THE INVENTION

The present invention provides its benefits across a broad spectrum of endeavors. It is applicant's intent that this specification and the claims appended hereto be accorded a breadth in keeping with the scope and spirit of the invention being disclosed despite what might appear to be limiting language imposed by the requirements of referring to the specific examples disclosed. Thus, to acquaint persons skilled in the pertinent arts most closely related to the present invention, a preferred embodiment of the system is disclosed for the purpose of illustrating the nature of the invention. The exemplary method of operating the system is described in detail according to the preferred embodiment, without attempting to describe all the various forms and modifications in which the invention might be embodied. As such, the embodiments described herein are illustrative, and as will become apparent to those skilled in the art, can be modified in numerous ways within the scope and spirit of the invention, the invention being measured by the appended claims and not by the details of the specification.

Although the following text sets forth a detailed description of numerous different embodiments, the legal scope of the description is defined by the words of the claims set forth at the end of this disclosure. The description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined herein, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, subparagraph (f).

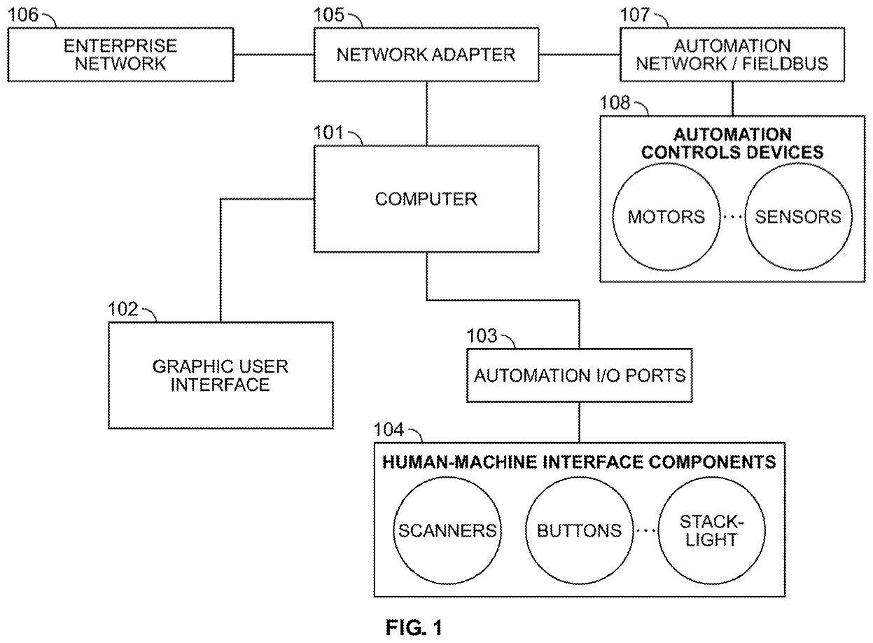

With reference to FIG. 1, shown is a schematic representation of the architecture of a human-machine execution system of the present invention. In some embodiments, the human-machine execution system is an integrated system comprising at least one computer (101) which can use an Intel processor and a microcontroller such as the STM32 to expose programmable digital and analog inputs and outputs (103) to which the human-machine interface components (104) are directly connected. In some embodiments, the graphical user interface (102) is connected to the computer through a display. In some embodiments, a touch screen is connected to the computer (101) through a high-definition multimedia interface to send the video signal and a universal serial bus interface to receive data related to the touch signal. A network interface is exposed through a network adapter (105) that is part of the computer (101) and connects the computer (101) to the enterprise network (106) via a TCP connection as well as to the automation network or fieldbus (107) to interface with automation control devices (108) such as robots, drives, sensors, etc. Notably the connection to automation control devices (108) is optional. The HME system uses computer (101) to execute the software and programs necessary to orchestrate an automated manufacturing operation as well as operate the functions of the human-machine interface. In some embodiments, more than one computer 101 may be employed, which can enable virtualization or distributed computing techniques, such as edge computing or the use of a distributed cluster, such as Kubernetes.

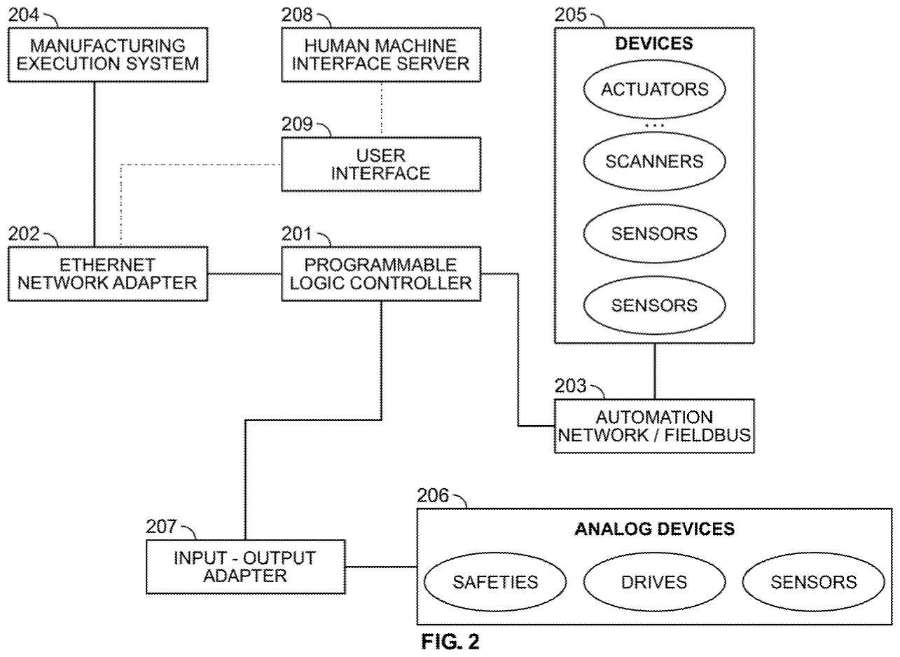

With reference to FIG. 2, shown is a schematic representation of the architecture of a traditional manufacturing system using a programmable logic controller. The programmable logic controller (201) runs the orchestration of the manufacturing process. It can exchange data with a manufacturing execution system (204) through the Ethernet adapter (202) which is necessary to change the orders of what needs to be manufactured, and to inform the manufacturing execution system of what is built. Automation devices (205 and 206) are connected to the programmable logic controller via respectively an automation fieldbus (203) and a set of optional analog and digital inputs and outputs (207). In some implementations, the user interface (209) is connected to a human-machine interface server (208) while in some other cases it is connected to the programmable logic controller via the network adapter (203). It is also possible to connect the user interface through the automation controls fieldbus (203). Complex logic sometimes referred to as business logic, e.g. logic that enables the traceability of material flows, tasks, and process steps, and variations thereof, can be executed on the programmable logic controller (201) to fulfill the manufacturing process, particularly when data from the manufacturing execution system requests a change in the manufacturing process. Here is seen how the need for multiple, discrete components and specifically separating the programmable logic controller from the user interference results in increased and undesirable complexity.

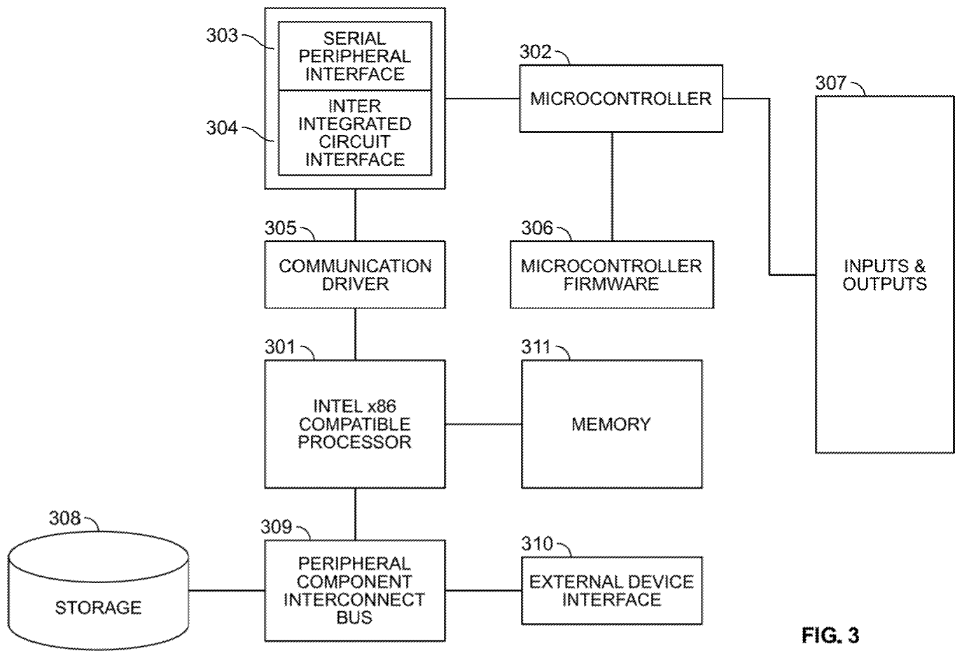

With reference to FIG. 3, shown is a schematic of the internal architecture of the computer (101) of the HME system. It is built around an Intel x86 compatible processor (301). The current embodiment uses an 8th generation Intel i7 processor and could use any Intel or AMD processor compatible with the modern Intel x86 architecture and instruction set. Peripherals that are found in common Intel-based computers such as the local storage (308) which uses a solid-state drive in the current implementation and all external interfaces (310) such as universal serial buses, serial AT attachments (SATA), etc. are connected to the system via a peripheral component interconnect bus (309). The augmentation of the Intel-based architecture lies in the addition of a microcontroller (302) such as the STM32 developed by ST Microelectronics that exposes multiple analog and digital inputs and outputs. The behavior of these inputs and outputs as well as the logic for scanning, communicating with, and controlling these inputs and outputs are implemented in the firmware (306) of the microcontroller which can be uploaded from a software executed in the Intel processor space through the serial peripheral interface (303). The communication between the Intel program space and the microcontroller (302) is ensured by an integrated circuit interface (304).

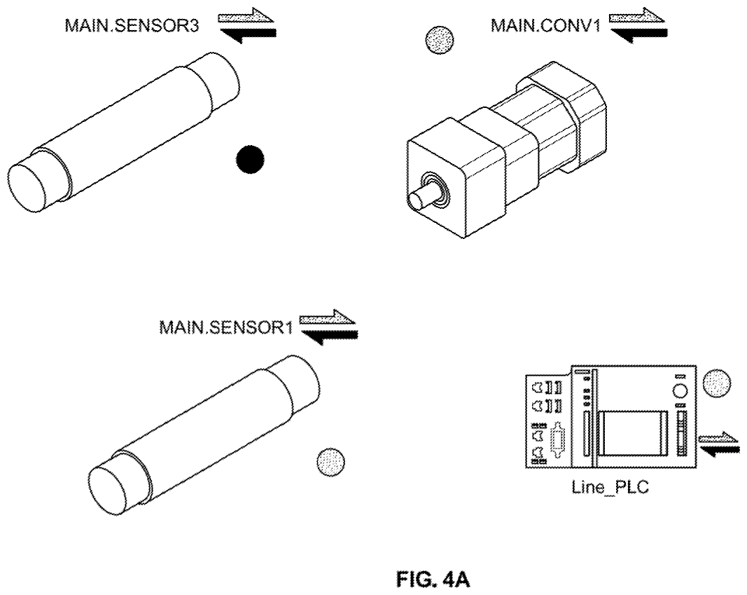

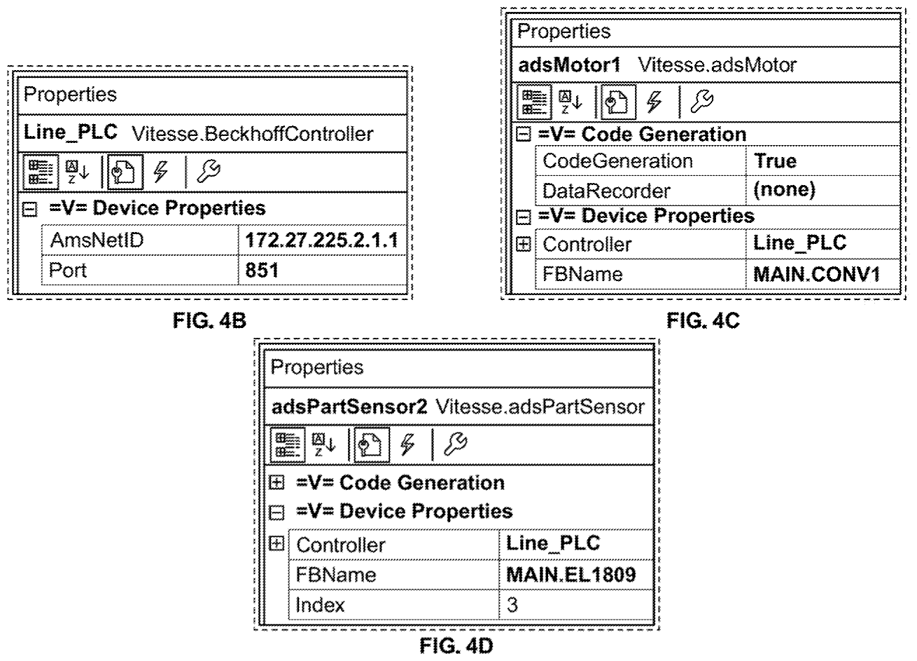

With reference to FIGS. 4A-4D, the HME system can connect with industrial or other types of automation controllers, and abstraction of the components connected to, or running on these controllers is automatically managed by the HME system so these components can be managed, for example, as if they were connected directly on HME system. In the GUI shown in FIG. 4A, shown for exemplary purposes as an instance of the Vitesse HME software running on the HME system for a production line, 2 sensors and 1 motor driving a conveyor are physically connected to a line PLC.

With reference to FIG. 4B, the HME system manages a software instance of the controller, detecting its content and allowing for the reading and writing of properties and commands hosted on that controller, remotely. Once connected to the controller, the HME system allows for an ongoing bi-directional connection with the remote PLC that enables the control of components connected to it, through accessing the IO port data, or logical routines that manage the IO port data. Such routines are commonly referred to as Function Blocks or Add-on Instruction (AOIs).

For instance, with reference to FIG. 4C, in one current implementation for a production line, the motor of the conveyor MAIN.CONV1 is managed by a simple Function Block named “MAIN.CONV1” on the controller named “Line_PLC.” In this implementation the “MAIN.CONV1” function block sets a variable in memory that passes the value to the physical output after checking that safety requirements are met.

With the HME system, the need to use logic in the PLC is obviated and, in some embodiments, the inputs and outputs on the PLC are directly exposed to the HME system where the logic lies, except when certain requirements such as specific needs for some low latency and/or safety critical processing require some logic to run on the PLC on which these inputs and outputs are physically connected.

For instance, as shown in FIG. 4D, in one current implementation an inductive part present sensor that is connected to the 3rd input of a Beckhoff EL1809 input block on the PLC is instantiated in the HME system and directly mapped to the 3rd index of the digital instance of the EL1809 input block. As a result, no programming is required at the PLC level. This allows for the programming of a more complex process at the HME system level, obviating the need for programming at the PLC level.

In some embodiments, the software components of the HME system can be installed on a PLC directly, as long as the controller utilizes an Intel or ARM based CPU. In such a mode of operation, the software doesn't have to rely on network connectivity and latency to communicate with the HME system and can manage the inputs and outputs of the HME system with performances close to those offered by the native development tools specific to the PLC. For example, on popular Beckhoff controllers, performance measurements have revealed that for a similar process execution, the scan time of the HME system on the PLC is about 10% faster than the native execution (ex: 2.6 ms vs. 2.4 ms).

One aspect of the communication between the PLC and the HME system is that it is event driven, as opposed to the most used communication model in the field of industrial automation that uses constant time-based scanning. With a traditional PLC, inputs and outputs are scanned at a given, constant frequency (called scan time, typically in the range of 2 to 100 Hz) and data is exchanged between PLCs and other industrial components over a fieldbus at another constant frequency (typically 0.5 to 10 Hz). This results in constant data exchange even if the values don't change. For instance, if a PLC monitors the rotational velocity of a motor, it will receive a numerical representation of the velocity on a given frequency, independently of the variation of the value. On the other hand, the HME system of the present invention is event-driven such that data updates are transmitted when data value changes initiate an event, independently of the elapsed time since the last event occurred. A threshold for the change can be set to control the granularity of the data acquisition and when an event should be sent, this allows for controlling the bandwidth required to keep signals up to date, based on a desired accuracy. The monitoring of the speed of different joints of an industrial robot, or the angular speed of a motor, using both fixed scan rate and event driven data recording has revealed that an event-based monitoring system reduces the network bandwidth by up to 120 times (12000%) for an equivalent set of data.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only the claims and equivalents.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Moreover, though the present disclosure has included description of one or more embodiments and certain variations and modifications, other variations and modifications are within the scope of the disclosure, e.g., the use of a certain component described above alone or in conjunction with other components may comprise a system, while in other aspects the system may be the combination of all of the components described herein, and in different order than that employed for the purpose of communicating the novel aspects of the present disclosure. Other variations and modifications may be within the skill and knowledge of those in the art, after understanding the present disclosure. This method of disclosure is intended to obtain rights which include alternative embodiments to the extent permitted, including alternate, interchangeable and/or equivalent structures, functions, ranges or steps to those claimed, whether such alternate, interchangeable and/or equivalent structures, functions, ranges or steps are disclosed herein, and without intending to publicly dedicate any patentable subject matter.

What is claimed is:

1. An integrated human-machine execution system for manufacturing automation, comprising:
a computer, a graphical user interface, one or more programmable input/outputs, one or more human-machine interface components, and a network adapter;
wherein the computer is enabled to execute all necessary software to operate the functions of the integrated system and orchestrate the execution of one or more automated manufacturing operations; and
wherein data updates are transmitted by the system when data value changes initiate an event, independently of time elapsed since occurrence of a prior event.

2. The human-machine execution system of claim 1, wherein the computer comprises:
a. a processor;
b. a microcontroller;
c. local storage;
d. one or more external interfaces and a component interconnect bus attached to the one or more programmable input/outputs;
e. firmware and a peripheral interface enabling communication between the processor and the microcontroller; and
f. an integrated circuit interface.

3. The human-machine execution system of claim 1, wherein the graphical user interface is enabled through a display connected to the computer.

4. The human-machine execution system of claim 1, wherein the graphical user interface is enabled through a touch screen connected to the computer through (a) a high-definition multimedia interface configured to send a video signal and (b) a universal serial bus interface configured to receive data related to a touch signal transmitted through the touch screen.

5. The human-machine execution system of claim 1, wherein a network interface is exposed through the network adapter to connect the computer to an enterprise network.

6. The human-machine execution system of claim 1, including an automation network or fieldbus configured to interface with one or more automation control devices.

7. The human-machine execution system of claim 1, wherein the system is configured to be connected to at least one external and discrete programmable logic controller attached to at least one automation component.

8. The human-machine execution system of claim 7, wherein instructions to the automation component are instantiated at the human-machine execution system, obviating programming at the programmable logic controllers.

9. A method of executing an automated manufacturing operation
a. providing an integrated human-machine execution system for manufacturing automation, comprising: a computer, a graphical user interface, one or more programmable input/outputs, one or more human-machine interface components, and a network adapter; wherein the computer is enabled to execute all necessary software to operate the functions of the integrated system and orchestrate the execution of the automated manufacturing operation;
b. connecting the human-machine execution system to an external and discrete programmable logic controller, wherein the programmable logic controller is attached to at least one automation component;
c. instantiating one or more instructions for the automation component at the human-machine execution system;
d. transmitting the instructions from the human-machine execution system to the automation component through the programmable logic controller without instructing or programming the programmable logic controller;

10. The method of claim 9, wherein instructions are transmitted by the human-machine execution system when data value changes initiate an event, independently of time elapsed since occurrence of a prior event.

11. The method of claim 9, wherein the computer comprises:
a. a processor;
b. a microcontroller;
c. local storage;
d. one or more external interfaces and a component interconnect bus attached to the one or more programmable input/outputs;
e. firmware and a peripheral interface enabling communication between the processor and the microcontroller; and
f. an integrated circuit interface.

12. The method of claim 9, wherein the graphical user interface is enabled through a display connected to the computer.

13. The method of claim 9, wherein the graphical user interface is enabled through a touch screen connected to the computer through (a) a high-definition multimedia interface configured to send a video signal and (b) a universal serial bus interface configured to receive data related to a touch signal transmitted through the touch screen.

14. The method of claim 9, wherein a network interface is exposed through the network adapter to connect the computer to an enterprise network.

15. The method of claim 9, including an automation network or fieldbus configured to interface with one or more automation control devices.

16. An integrated human-machine execution system for manufacturing automation, comprising:
a computer, a graphical user interface, one or more programmable input/outputs, one or more human-machine interface components, and a network adapter;
wherein the computer is enabled to execute all necessary software to operate the functions of the integrated system and orchestrate the execution of one or more automated manufacturing operations;
wherein data updates are transmitted by the system when data value changes initiate an event, independently of time elapsed since occurrence of a prior event;
wherein the system is configured to be connected to at least one external and discrete programmable logic controller attached to at least one automation component, and wherein instructions to the automation component are instantiated at the human-machine execution system, obviating programming at the programmable logic controllers.
